(19) United States
(12) Patent Application Publication
(10) Pub. No.: US 2025/0218431 A1
(43) Pub. Date: Jul. 3, 2025

(54) METHODS, SYSTEMS, AND APPARATUSES FOR EXTRACTING AND DETERMINING INSIGHT DATA

(71) Applicant: Stagwell Marketing Cloud, New York, NY (US)

(72) Inventors: Eric Walzthony, New York, NY (US); Mansoor Basha, New York, NY (US)

(21) Appl. No.: 19/007,859

(22) Filed: Jan. 2, 2025

Related U.S. Application Data
(60) Provisional application No. 63/617,278, filed on Jan. 3, 2024.

(51) Int. Cl. G10L 15/18; G10L 15/26

(52) U.S. Cl. CPC G10L 15/1815; G10L 15/26

(57) ABSTRACT

Methods, apparatuses, and systems are described for generating one or more audience sentiment reports based on audio data of video files associated with one or more focus groups. Audience sentiment towards one or more topics discussed during one or more focus group sessions may be determined based on audio data associated with a focus group. The audio data may be processed via a language processing artificial intelligence (AI) module to generate transcription information. The transcription information may be processed via a generative AI module to generate insight information. The insight information may be processed via a predictive AI module to generate an audience sentiment report that includes transcription and diarization information, audience sentiment for each speaker and each topic, and/or future focus group questions associated with the focus group.

### CROSS-REFERENCE TO RELATED APPLICATION

This application claims the priority benefit of U.S. Provisional Application No. 63/617,278, filed Jan. 3, 2024, the entirety of which is incorporated herein by reference.

### BACKGROUND

Creating meaningful and targeted marketing campaigns has become excessively difficult, especially in today's market where people are being constantly sent a plurality of content, advertisements, commercials, communications, and messages that may not be relevant to the individual. Audience focus groups have been used to determine audience sentiment towards certain content topics or products. However, conventional methods used by existing computing platforms to analyze and process information discussed during these focus groups do not efficiently or adequately determine audience sentiment associated with one or more topics discussed during the focus group sessions. Moreover, creating customized communications and targeted questions for audience members attending focus groups can be time consuming. These conventional methods mainly involve a person or group of people listening into the focus group discussion in order to attempt to identify the topics that are discussed and attempt to correlate audience sentiment towards the topics discussed during the focus group discussion.

Generating natural language from machine representation systems is a common and increasingly important function. Existing natural language generation (NLG) systems, such as translators, summarizers, dialog generators, etc., while common, cannot produce variable output based on user-desired tunable specifications. Additionally, such existing systems cannot take input in the form of a variable form of text and a variable set of specifications and output a transformed version of the input text according to the specifications. Further, such existing systems are generally not readily extendable. Conventional NLG systems simply generate tunable stylized text (such as, for example, one or more sentences) by transforming received user text input and one or more user-originated stylistic parameters (directed to polarity of subjective opinion, such as sentiments, valence, emotions, formal, business, readability, etc.) in vector form, using unsupervised natural language processing (NLP) systems such as rule-based and/or machine learning-based classifiers and/or regressors, metric computation systems as style scorers, etc.

### SUMMARY

It is to be understood that both the following general description and the following detailed description are exemplary and explanatory only and are not restrictive.

Methods, systems, and apparatuses for determining audience sentiment associated with one or more topics of a focus group are described herein. Audio data related to a focus group may be processed in order for determine audience sentiment towards one or more topics discussed during one or more focus group sessions. The audio data may be processed via a language processing artificial intelligence (AI) module to generate transcription information of the audio data. The transcription information may be processed via a generative AI module to generate insight information of the audio data. The insight information may be processed via a predictive AI module to generate an audience sentiment report that includes transcription and diarization information, audience sentiment for each speaker and each topic, and/or future focus group questions associated with the focus group. The audience sentiment report may be transmitted for further processing such as for developing audience insight and correlation data, developing marketing/advertisement campaigns, and/or for product development.

In an embodiment, are methods for receiving, by a computing device, audio data of a video file associated with a focus group, generating, via a language processing AI module, based on the audio data, transcription information associated with the video file, generating, via a generative AI module, based on the transcription information, insight information associated with the video file, generating, via a predictive AI module, based on the insight information, an audience sentiment report associated with the focus group, facilitating, by the computing device, transmission of the audience sentiment report.

In an embodiment, are apparatuses comprising one or more processors, and a memory storing processor-executable instructions that, when executed by the one or more processors, cause the apparatus to receive audio data of a video file associated with a focus group, generate, via a language processing AI module, based on the audio data, transcription information associated with the video file, generate, via a generative AI module, based on the transcription information, insight information associated with the video file, generate, via a predictive AI module, based on the insight information, an audience sentiment report associated with the focus group, and facilitate, by the computing device, transmission of the audience sentiment report.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of the present description serve to explain the principles of the apparatuses and systems described herein:

FIG. 1 shows an example system;

FIG. 2 shows an example process flow;

FIGS. 3A-3C show example interfaces;

FIGS. 4A-4B show an example interface;

FIG. 5 shows an example machine learning system;

FIG. 6 shows a flowchart of an example machine learning method; and

FIG. 7 shows a flowchart of an example method.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, magnetic storage devices, memristors, Non-Volatile Random Access Memory (NVRAM), Random Access Memory (RAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

This detailed description may refer to a given entity performing some action. It should be understood that this language may in some cases mean that a system (e.g., a computer) owned and/or controlled by the given entity is actually performing the action.

Creating meaningful and targeted marketing campaigns has become excessively difficult, especially in today's market where people are being constantly sent a plurality of content, advertisements, commercials, communications, and messages that may not be relevant to the individual. Audience focus groups have been used to determine audience sentiment towards certain content topics or products. However, conventional methods used by existing computing platforms to analyze and process information discussed during these focus groups do not efficiently or adequately determine audience sentiment associated with one or more topics discussed during the focus group sessions. Moreover, creating customized communications and targeted questions for audience members attending focus groups can be time consuming. These conventional methods mainly involve a person or group of people listening into the focus group discussion in order to attempt to identify the topics that are discussed and attempt to correlate audience sentiment towards the topics discussed during the focus group discussion.

Thus, machine learning systems have been increasingly implemented in order to compile large amounts of audience data from several data sources in order to analyze complex relationships associated with the audience data in order to determine audience sentiment towards certain content. However, existing natural language generation (NLG) systems, such as translators, summarizers, dialog generators, etc., while common, cannot produce variable output based on user-desired tunable specifications. Additionally, such existing systems cannot take input in the form of a variable form of text and a variable set of specifications and output a transformed version of the input text according to the specifications. Further, such existing systems are generally not readily extendable. Conventional NLG systems simply generate tunable stylized text (such as, for example, one or more sentences) by transforming received user text input and one or more user-originated stylistic parameters (directed to polarity of subjective opinion, such as sentiments, valence, emotions, formal, business, readability, etc.) in vector form, using unsupervised natural language processing (NLP) systems such as rule-based and/or machine learning-based classifiers and/or regressors, metric computation systems as style scorers, etc.

Moreover, conventional computing systems lack an efficient computing architecture in order to implement these existing NLG systems. For example, these conventional computing systems are unreliable, inefficient, and lack the ability to separately analyze different aspects of user data, such as video data, that may include text data, associated with a plurality of users, and compile results of each aspect in order to generate audience sentiment information related to a plurality of topics. Thus, these conventional computing systems do not operate effectively in order to implement the NLG, or machine learning, systems because they are prone to inaccurate data management that leads to improperly generating audience sentiment information that does not accurately represent intended audiences.

By way of example, the present methods and systems address these challenges by generating audience sentiment information and sending the audience sentiment information to one or more user devices. The machine learning module may be configured into a plurality of modules, wherein each module may be configured to separately analyze different aspects of a plurality of users such as video data, that includes text data, associated with the plurality of users. For example, a machine learning platform may comprise a system of computing devices, servers, software, etc. that is configured to implement one or more machine learning models (e.g., generative artificial intelligence, predictive artificial intelligence, neural networks, deep-learning models, text-based learning models, large language models, natural language processing applications/models, etc.) to generate audience sentiment information based video data, including text data of the video data, associated with a plurality of users.

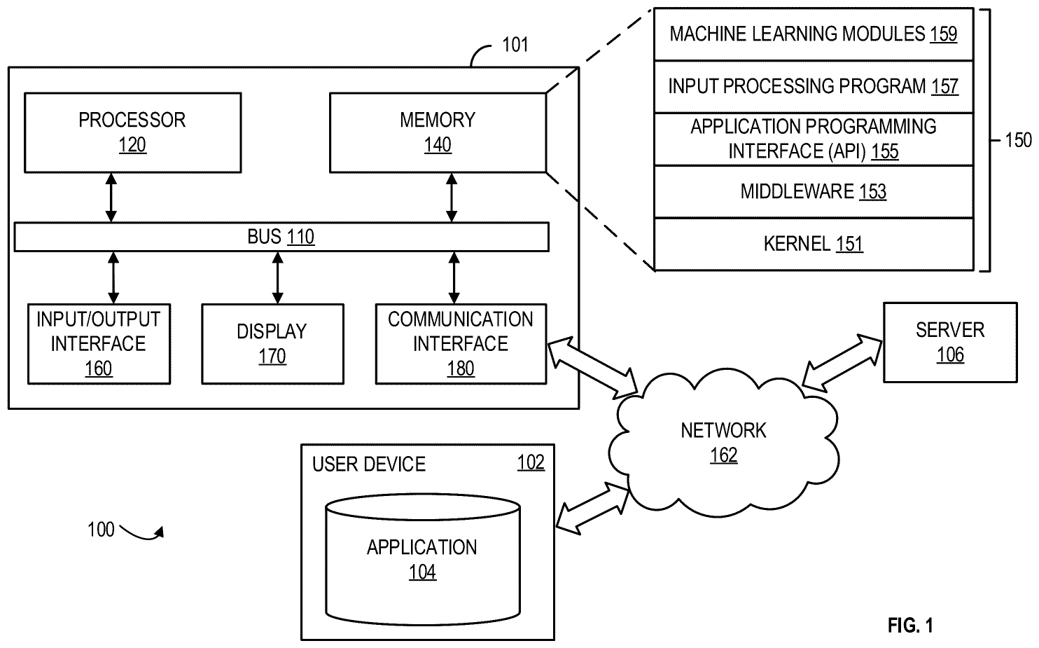

FIG. 1 shows an example system 100 for generating an audience sentiment report based on audio data of a media asset (e.g., a video file such as a MP4 file, an AVI file, a WMV file, etc.) associated with a focus group. The video file may be processed to extract audio data of the video file and convert the audio data from a first format to a second format (e.g., MP3, WAV, AAC, WMA, MP4, M4A, FLAC, etc.). The audio data may be processed via a language processing artificial intelligence (AI) module to generate transcription information of the audio data. The transcription information may be processed via a generative AI module to generate insight information of the audio data. The insight information may be processed via a predictive AI module to generate an audience sentiment report associated with the focus group. The audience sentiment report may be transmitted for further processing such as for developing audience insight and correlation data, developing marketing/advertisement campaigns, and/or for product development. The system 100 may include a backend platform device 101, a user device 102, and one or more external servers 106. In an example, the backend platform device 101 may be configured to receive video data (e.g., a video file) of focus group, extract audio data from the video data, and generate, based on one or more machine learning models, one or more audience sentiment reports and send the one or more audience sentiment reports to one or more devices for further processing such as for developing audience insight and correlation data, developing marketing/advertisement campaigns, and/or for product development. In an example, the backend platform device 101 may be in communication with the user device 102, and the one or more external servers 106 via a network (e.g., network 162).

The backend platform device 101 may include a bus 110, one or more processors 120, a memory 140, an input/output interface 160, a display 170, and a communication interface 180. In certain examples, the backend platform device 101 may omit at least one of the aforementioned elements or may additionally include other elements. The backend platform device 101 may comprise, for example, a host server capable of processing the user inputs in order to generate and distribute the customized content.

The bus 110 may comprise a circuit for connecting the bus 110, the one or more processors 120, the memory 140, the input/output interface 160, the display 170, and/or the communication interface 180 to each other and for delivering communication (e.g., a control message and/or data) between the bus 110, the one or more processors 120, the memory 140, the input/output interface 160, the display 170, and/or the communication interface 180.

The one or more processors 120 may include one or more of a Central Processing Unit (CPU), an Application Processor (AP), or a Communication Processor (CP). The one or more processors 120 may control, for example, at least one of the bus 110, the memory 140, the input/output interface 160, the display 170, and/or the communication interface 180 of the backend platform device 101 and/or may execute an arithmetic operation or data processing for communication. As an example, the one or more processors 120 may cause the backend platform device 101 to process the user input via the input processing program 157 and the machine learning programs/models 159 in order to generate and/or distribute the customized content. The processing (or controlling) operation of the one or more processors 120 according to various embodiments is described in detail with reference to the following drawings.

The processor-executable instructions executed by the one or more processors 120 may be stored and/or maintained by the memory 140. The memory 140 may include a volatile and/or non-volatile memory. The memory 140 may include random-access memory (RAM), flash memory, solid state or inertial disks, or any combination thereof. As an example, the memory 140 may include an Embedded MultiMedia Card (eMMC). The memory 140 may store, for example, a command or data related to at least one of the bus 110, the one or more processors 120, the memory 140, the input/output interface 160, the display 170, and/or the communication interface 180 of the backend platform device 101. According to various examples, the memory 140 may store software and/or a program 150 or may comprise firmware. For example, the program 150 may include a kernel 151, a middleware 153, an Application Programming Interface (API) 155, an input processing program 157, and/or machine learning programs/models 159, and/or the like, configured for controlling one or more functions of the backend platform device 101 and/or an external device (e.g., the one or more servers 106). At least one part of the kernel 151, middleware 153, or API 155 may be referred to as an Operating System (OS). The memory 140 may include a computer-readable recording medium (e.g., a non-transitory computer-readable medium) having a program recorded therein to perform the methods according to various embodiments by the one or more processors 120. In an example, the memory 140 may store the customized content.

The kernel 151 may control or manage, for example, system resources (e.g., the bus 110, the one or more processors 120, the memory 140, etc.) used to execute an operation or function implemented in other programs (e.g., the middleware 153, the API 155, the input processing program 157, or the machine learning program/model 159). Further, the kernel 151 may provide an interface capable of controlling or managing the system resources by accessing individual elements of the data capture device 101 in the middleware 153, the API 155, the input processing program 157, or the machine learning program/model 159.

The middleware 153 may perform, for example, a mediation role, so that the API 155, the input processing program 157, and/or the machine learning programs/models 159 can communicate with the kernel 151 to exchange data. Further, the middleware 153 may handle one or more task requests received from the input processing program 157 and/or the machine learning programs/models 159 according to a priority. For example, the middleware 153 may assign a priority of using the system resources (e.g., the bus 110, the one or more processors 120, or the memory 140) of the backend platform device 101 to at least one of the input processing program 157 and/or the machine learning programs/models 159. For example, the middleware 153 may process the one or more task requests according to the priority assigned to at least one of the application programs, and thus, may perform scheduling or load balancing on the one or more task requests.

The API 155 may include at least one interface or function (e.g., instruction), for example, for file control, window control, video processing, and/or character control, as an interface capable of controlling a function provided by the input processing program 157 and/or the machine learning program/model 159 in the kernel 151 or the middleware 153.

As an example, the input processing program 157 and the machine learning programs/models 159 may be independent of each other or integrally combined, in whole or in part.

The input processing program 157 may include logic (e.g., hardware, software, firmware, etc.) that may be implemented to process video data (e.g., video file such as a MP4 file, an AVI file, a WMV file, etc.) of a focus group. In an example, the video data may be received by the backend platform device 101 from one of the user devices 102, wherein the backend platform device 101 may be configured to extract the audio data from the video data. In another example, the user device 102 may be configured to extract the audio data from the video data and send the audio data to the backend platform device 101. The user devices 102 may comprise a laptop computer, a mobile phone, a smart phone, a tablet computer, a wearable device, a smartwatch, a desktop computer, a smart television, and the like. The user devices 102 may be configured to include an application 104 that may be configured to receive, generate, or record a video file associated with a focus group discussion. In an example, the application 106 may comprise a mobile application or a web browser. The user device 102 may execute the application 106, wherein the application 106 may cause the user device 102 to record a focus group discussion and generate a video file of the focus group discussion. The user device 102 may send the video file, and/or the audio data of the video file, to the backend platform device 101, wherein the backend platform device 101 may generate an audience sentiment report based on the audio data of the video file. The input processing program 157 may be configured to use one or more machine learning modules/models 159 to generate the audience sentiment report. The audience sentiment report may comprise one or more characteristics associated with audience sentiment towards one or more topics discussed during the focus group discussion. For example, the input processing program 157 may determine that a first topic received negative audience sentiment (e.g., sentiment score of 0.92).

The one or more machine learning modules/models 159 may include logic (e.g., hardware, software, firmware, etc.) to implement the one or more machine learning modules/models 159. The one or more machine learning modules/models 159 may comprise at least a language processing artificial intelligence (AI) module, a generative AI module, and a predictive AI module. The language processing AI module may comprise one or more of a text-based learning model, a large language model, or a natural language processing application. The input processing program 157 may initially process the video data (e.g., video file such as a MP4 file, an AVI file, a WMV file, etc.), extract audio data from the video data, and convert the audio data from a first format to a second format (e.g., MP3, WAV, AAC, WMA, MP4, M4A, FLAC, etc.). The input processing program 157 may provide the formatted audio data to the language processing AI module, wherein the language processing AI module may generate transcription information associated with the video data/file based on the audio data. The transcription information may comprise text data synchronized with one or more segments of the audio data, wherein the text data may be associated with the one or more speakers (e.g., individuals that were talking during the focus group discussion) associated with the audio data. For example, the language processing AI module may be configured to extract, or generate, text data (e.g., transcription of the audio data) from the audio data. The audio data may be associated with, or comprise, audio data of the one or more speakers during the focus group discussion. The language processing AI module may extract, or generate, the text data of the one or more speakers. The language processing AI module may determine the one or more speakers of the audio data and associate the one or more speakers with the text data. For example, the language processing AI module may associate each speaker with the words spoken (e.g., text data) during the focus group discussion. For example, the language process AI module may process the audio data via a diarization process (e.g., unsupervised machine learning technique) to determine the speakers in the audio data and associate the speakers with the text data of each speaker. The language processing AI module may then synchronize, or align, the text data associated with the one or more speakers with one or more segments of the audio data. In an example, the audio data may comprise timing information. The text data may be synchronized with the timing information of the audio data. In an example, the language processing AI module may comprise a plurality of language processing AI modules. For example, a first language processing AI module may extract, or generate, the text data, a second language processing AI module may determine the one or more speakers of the audio data, and a third language processing AI module may associate the one or more speakers with the text data of the audio data (e.g., via diarization process).

The language processing AI module may provide the transcription information to the generative AI module, wherein the generative AI module may generate insight information associated with the video data/file based on the transcription information. The insight information may comprise one or more of a text summary of the text data associated with the one or more speakers of the audio data, one or more questions associated with the video data/focus group, and/or one or more topics associated with the video data/focus group. For example, the generative AI module may generate a text summary of what each speaker discussed and/or the topics discussed by each speaker. In one example, the generative AI module may also generate one or more questions (e.g., survey questions) based on the topics of the focus group that may be presented to audience members of the focus group or future focus groups. In addition, reasoning for each question of the one or more questions may be generated. For example, the questions may be implemented in order to improve the direction of a next focus group survey, or next set of questions. In an example, the generative AI module may generate one or more questions that may be distributed across one or more focus groups.

The generative AI module may provide the insight information to the predictive AI module, wherein the predictive AI module may generate an audience sentiment report associated with the focus group based on the insight information. The audience sentiment report may comprise information indicative of audience sentiment associated with one or more topics associated with the video data/file of the focus group discussion. In an example, the audience sentiment report may comprise an aggregation of the transcription information (e.g., text data and speaker and text diarization information). In an example, the audience sentiment report may compile statistics of the focus group discussion such as when each speaker spoke or did not speak, the topics discussed by each speaker, how long did each speaker speak, how many words were spoken by each speaker, audience sentiment labels for each topic, and/or audience sentiment scores for each topic. The predictive AI module may further format the audience sentiment report into one or more data file formats. For example, the one or more data file formats may comprise one or more of an XML file, a PDF file, or a word document file.

In an example, the backend platform device 101 may receive additional video files/data associated with the focus group. For example, the focus group may conduct a plurality of discussions and/or the focus group may comprise a larger focus group that comprises smaller sub-groups (e.g., associated with sub-topics or sub-categories). An overall audience sentiment report may be generated for the focus group that may include sub-reports for the sub-groups of the focus group. For example, a video file may be generated based on each sub-group discussion. The input processing program 157 and the machine learning modules/models 159 may process the additional video files/data and update the audience sentiment report based on additional audience sentiment reports (e.g., sub-reports) generated from the audio data of the additional video files/data. For example, the input processing program 157 may extract/generate audio data from each video file/data and convert the audio data from a first format to a second format. The input processing program 157 may provide the audio data to the machine learning modules/models 159. The language processing AI module may generate transcription information for each video file/data based on the formatted audio data. The generative AI module may generate insight information for each video file/data based on the transcription information. The predictive AI module may generate the additional audience sentiment reports (e.g., sub-reports) based on the transcription information and update the audience sentiment report based on the additional audience sentiment reports (e.g., sub-reports) generated based on each video file/data.

In an example, the machine learning modules/models 159 may comprise an additional/second generative AI module. The backend platform device 101 may receive one or more queries associated with one or more audience sentiment reports. The additional/second generative AI module may generate one or more outputs based on the one or more queries. For example, the generative AI module, or an additional/second generative AI module may further narrow or filter data of the audience sentiment report based on the one or more queries. In one example, one or more summaries of the audience sentiment data be generated based on the one or more queries. In another example, the one or more topics may be analyzed based on the one or more queries. In another example, the results of the audience sentiment report may be grouped based on the one or more queries. In another example, the questions (e.g., future audience questions) and reasoning for the questions may be updated/generated based on the one or more queries and the audience report may be updated/generated based on the one or more queries.

The input/output interface 160 may include an interface for delivering an instruction or data input from a user (e.g., an operator of the backend platform device 101) or from a different external device (e.g., user device 102 or servers 106) to the different elements of the backend platform device 101. The input/output interface 160 may further include an interface for outputting one or more user interfaces to the user. For example, the input/output interface 160 may comprise a display, such as a touch screen display, and/or one or more physical input interfaces (e.g., keyboard, mouse, etc.) configured to receive user inputs. Further, the input/output interface 160 may output an instruction or data received from one or more elements of the backend platform device 101 to one or more external devices (e.g., user device 102 or servers 106).

The display 170 may include various types of displays, for example, a Liquid Crystal Display (LCD) display, a Light Emitting Diode (LED) display, an Organic Light-Emitting Diode (OLED) display, a MicroElectroMechanical Systems (MEMS) display, or an electronic paper display. The display 170 may display, for example, a variety of contents (e.g., text, image, video, icon, symbol, etc.) to the user. The display 170 may include a touch screen. The input processing program 157 may cause the display 170 to output an interface displaying the audience sentiment data based on the audience sentiment report. The audience sentiment data may be aggregated/compiled in order to display one or more graphs of the words spoken by each speaker and the times at which the words were spoken by each speaker. In addition, the interface may be configured to output summary information associated with the number of speakers of a video asset (e.g., focus group), the words spoken by each speaker (e.g., average words per speaker), the topics discussed, and/or audience sentiment data (e.g., audience sentiment labels and/or scores) associated with the topics discussed and/or with each speaker (e.g., average sentiment per speaker). In an example, the summary information may include a short summary of the focus group discussion and key words associated with the focus group discussion.

The communication interface 180 may establish, for example, communication between the data capture device 101 and one or more external devices (e.g., the display device 102, the electronic device 104, and/or the server 106). For example, the communication interface 180 may communicate with the one or more external devices (e.g., the user device 102 and/or the servers 106) by being connected to a network 162 through wireless communication or wired communication. The network 162 may include, for example, at least one of a telecommunications network, a computer network (e.g., LAN or WAN), the Internet, and/or a telephone network.

The communication interface 180 may be configured to communicate with the one or more external devices (e.g., user device 102 or server 106) via the network 162 (e.g., Internet, LAN, etc.). In an example, the communication interface 180 may be configured to access the network 162 via a wireless communication interface such as a cellular communication protocol. The cellular communication protocol may comprise at least one of Long-Term Evolution (LTE), LTE Advance (LTE-A), Code Division Multiple Access (CDMA), Wideband CDMA (WCDMA), Universal Mobile Telecommunications System (UMTS), Wireless Broadband (WiBro), Global System for Mobile Communications (GSM), and the like. In an example, the wireless communication interface may be configured to use a near-distance communication. The near-distance communication interface may include for example, at least one of Wireless Fidelity (WiFi), Bluetooth, Bluetooth Low Energy (BLE), Near Field Communication (NFC), Global Navigation Satellite System (GNSS), and the like. According to a usage region or a bandwidth or the like, the GNSS may include, for example, at least one of Global Positioning System (GPS), Global Navigation Satellite System (GLONASS), BeiDou Navigation Satellite System (BDS), Galileo, the European global satellite-based navigation system, and the like. Hereinafter, the “GPS” and the “GNSS” may be used interchangeably in the present document.

The external servers 106 may include a group of one or more external servers. For example, all or some of the operations executed by the backend platform device 101 may be executed in a different server or a plurality of external servers 106. In an example, if the backend platform device 101 needs to perform a certain function or service either automatically or based on a request, the backend platform device 101 may request at least some parts of functions related thereto alternatively or additionally to a different server 106 or plurality of external servers 106 instead of executing the function or the service autonomously. One or more of the external servers 106 may execute the requested function or additional function, and may deliver a result thereof to the backend platform device 101. The backend platform device 101 may provide the requested function or service either directly or by additionally processing the received result. For example, a cloud computing, distributed computing, or client-server computing technique may be used.

The backend platform device 101 and/or the external servers 106 may include one or more databases. In one example, the one or more databases may comprise one or more relational databases that use structured query language (SQL) for storing and processing data. In another example, the one or more databases may comprise one or more non-relational databases that use non-structured query language (NoSQL) for storing and processing data. As an example, the databases may be used to store the audience sentiment reports associated with each focus group and/or sub-group. In addition, the database may store audience demographic information (e.g., age, gender, employment status, etc.) associated with each focus group and/or sub-group. In an example, the database may store a plurality of statistical data and reference sources. A statistic may have an associated reference source indicating an origin of the at least one statistic, for example.

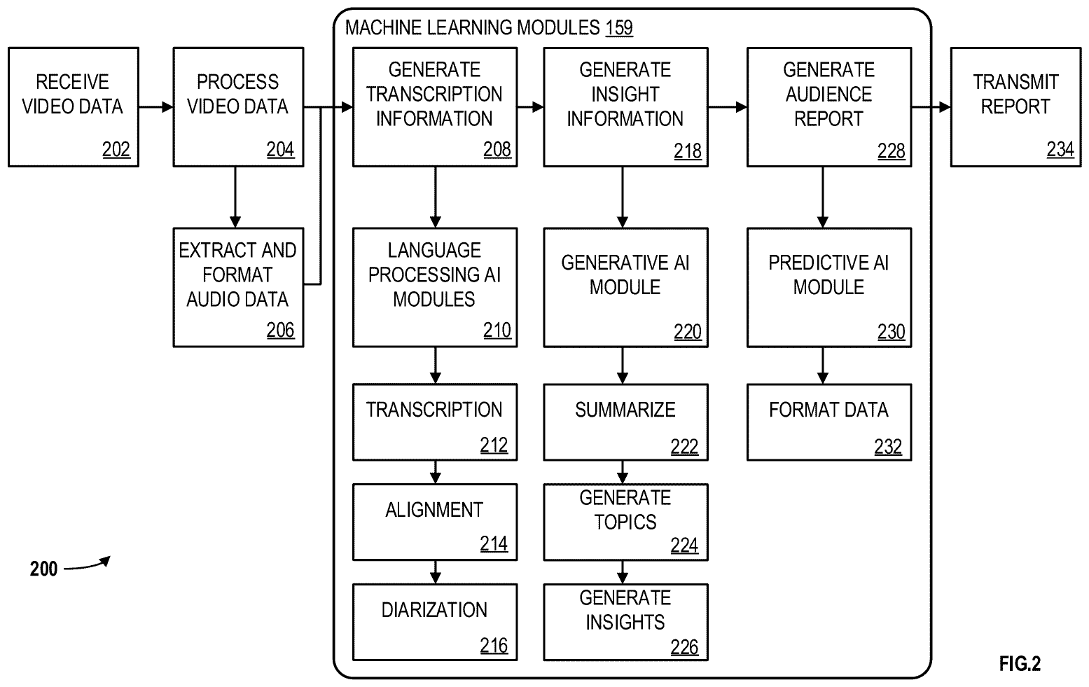

FIG. 2 shows an example process flow 200 for generating the audience sentiment reports based on the audio data extracted from the video data/files associated with the focus groups. At 202, video data (e.g., video file such as a MP4 file, an AVI file, a WMV file, etc.) generated from a focus group discussion may be received. At 204, the video data may be processed, wherein audio data may be extracted from the video data and converted from a first format to a second format (e.g., MP3, WAV, AAC, WMA, MP4, M4A, FLAC, etc.) at 206. The formatted audio data may be provided to the machine learning modules 159, wherein 208-228 may be implemented by the machine learning modules 159. For example, the machine learning modules 159 may comprise a plurality of machine learning modules such as a language processing artificial intelligence (AI) module 210, a generative AI module 220, and/or a predictive AI module 230.

At 208, the language processing AI module 210 may generate transcription information based on the formatted audio data. The language processing AI module 210 may comprise one or more of a text-based learning model, a large language model, or a natural language processing application. The transcription information may comprise text data, or transcription data, of the audio data synchronized with one or more segments of the audio data, wherein the text data may be associated with the one or more speakers (e.g., one or more individuals that were talking during the focus group discussion) of the audio data. At 212, the language processing AI module 210 may be configured to extract, or generate, text data (e.g., transcription of the audio data) from the audio data. The audio data may be associated with, or comprise, audio data of the one or more speakers during the focus group discussion. The language processing AI module 210 may extract, or generate, the text data of the one or more speakers. At 214, may determine the one or more speakers of the audio data and associate the one or more speakers with the text data. For example, the language processing AI module 210 may associate each speaker with the words spoken (e.g., text data) during the focus group discussion. At 216, the language processing AI module 210 may perform a diarization process and synchronize, or align, the text data associated with the one or more speakers with one or more segments of the audio data. In an example, the audio data may comprise timing information. The text data may be synchronized with the timing information of the audio data. In an example, the language processing AI module 210 may comprise a plurality of language processing AI modules. For example, a first language processing AI module may extract, or generate, the text data, a second language processing AI module may determine the one or more speakers of the audio data, and a third language processing AI module may associate the one or more speakers with the text data of the audio data. The language processing AI module 210 may provide the transcription information to the generative AI module 220 at 218.

At 218, the generative AI module 220 may generate insight information based on the transcription information. The insight information may comprise one or more of a text summary of the text data associated with the one or more speakers of the audio data, one or more questions associated with the video data, and/or one or more topics associated with the video data. For example, at 222, the generative AI module 220 may generate a text summary of what each speaker discussed and/or the topics discussed by each speaker. At 224, the generative AI module 220 may also generate one or more topics associated with the focus group. At 226, the generative AI module may generate audience insight information based on the one or more topics. For example, one or more questions (e.g., survey questions) may be generated based on the one or more topics that may be presented to audience members of the focus group or future focus groups. In addition, reasoning for each question of the one or more questions may be generated. For example, the questions may be implemented in order to improve the direction of a next focus group survey, or set of questions. In an example, the one or more questions may be distributed across one or more focus groups. The generative AI module 220 may provide the insight information to the predictive AI module 230 at 228.

At 228, the predictive AI module 230 may generate an audience sentiment report based on the insight information. The audience sentiment report may comprise information indicative of audience sentiment associated with one or more topics associated with the video data of the focus group discussion. In an example, the audience sentiment report may comprise an aggregation of the transcription information (e.g., text data and speaker and text diarization information). In an example, the audience sentiment report may compile statistics of the focus group discussion such as when each speaker spoke or did not speak, the topics discussed by each speaker, how long each speaker spoke, how many words were spoken by each speaker, audience sentiment labels for each topic, and/or audience sentiment scores for each topic. In an example, the audience sentiment report may include summary information associated with the number of speakers of a video asset (e.g., focus group), the words spoken by each speaker (e.g., average words per speaker), the topics discussed, and/or audience sentiment data (e.g., audience sentiment labels and/or scores) associated with the topics discussed and/or with each speaker (e.g., average sentiment per speaker). In an example, the summary information may include a short summary of the focus group discussion and key words associated with the focus group discussion. At 232, the predictive AI module 230 may further format the audience sentiment report into one or more data file formats. For example, the one or more data files may comprise one or more of an XML file, a PDF file, or a word document file. The audience sentiment report may be transmitted at 234. For example, the audience sentiment report may be used to provide insights of audience members of the focus group, to develop marketing/advertisement campaigns, and/or for product development.

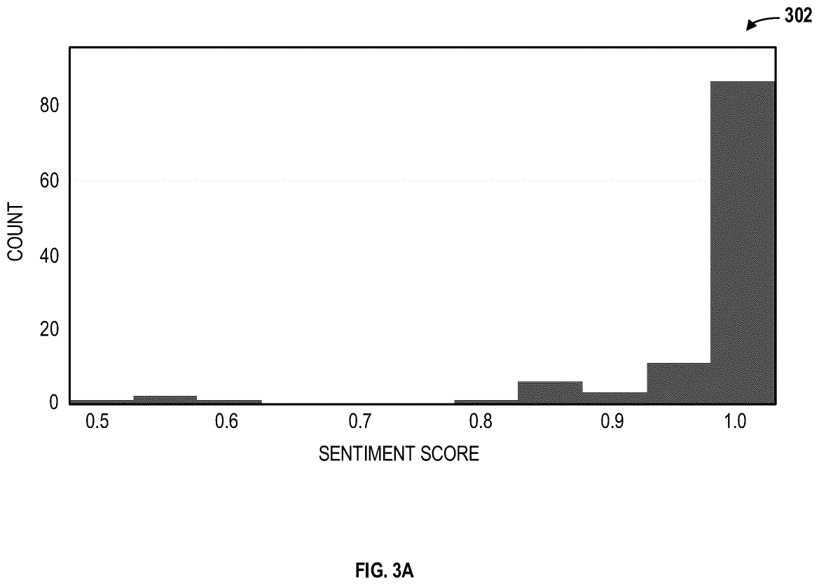

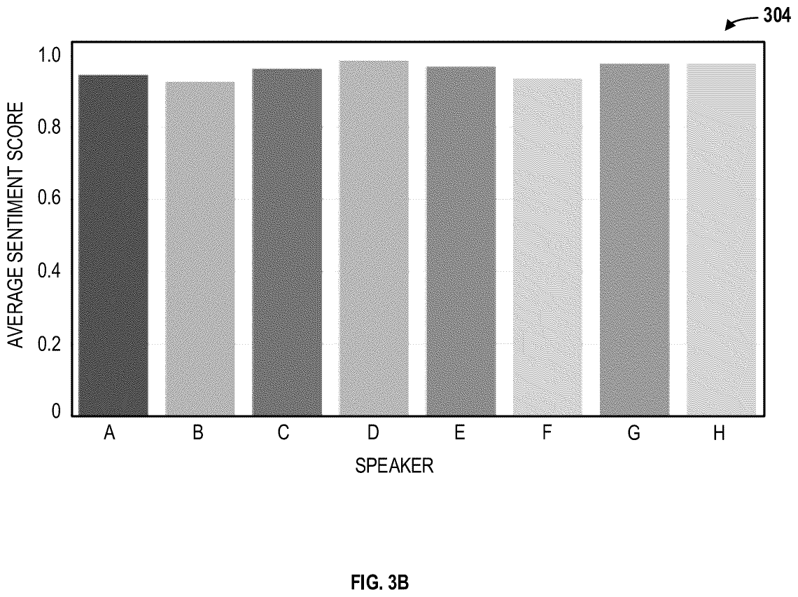

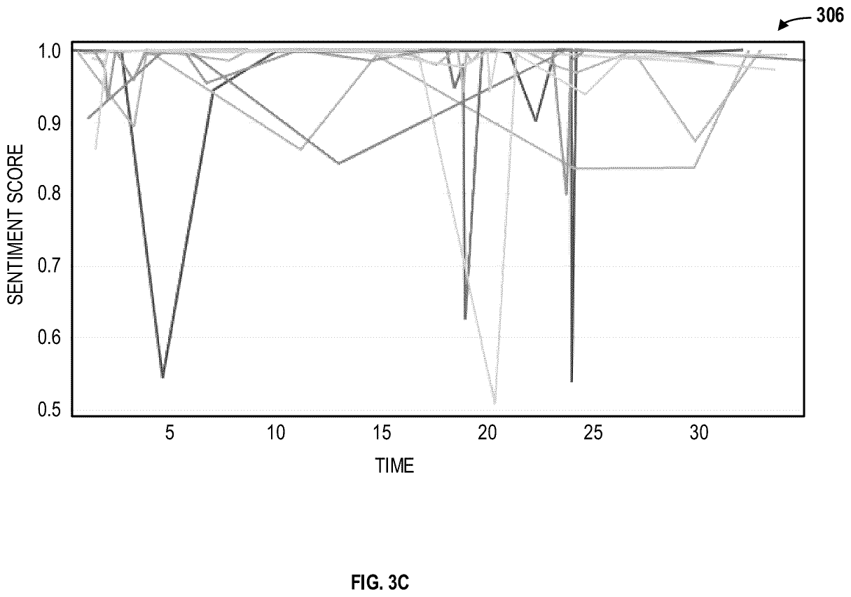

FIGS. 3A-3C show an example interfaces 302, 304, and 306 for displaying audience sentiment data associated with a focus group discussion. For example, graphical user interfaces 302, 304, and 306 may be displayed to the user that include graphical depictions of the audience sentiment data. As shown in FIG. 3A, a sentiment score distribution may be displayed according to a number of words per sentiment score. As shown in FIG. 3B, an average sentiment score per speaker may be displayed. As shown in FIG. 3C, a graph of a sentiment score per speaker may be displayed.

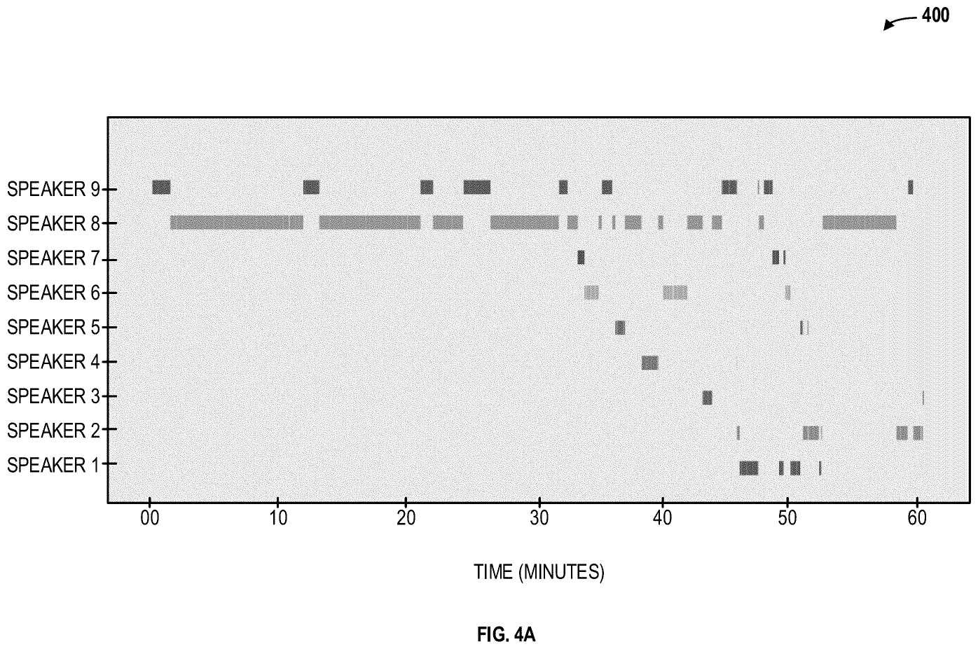

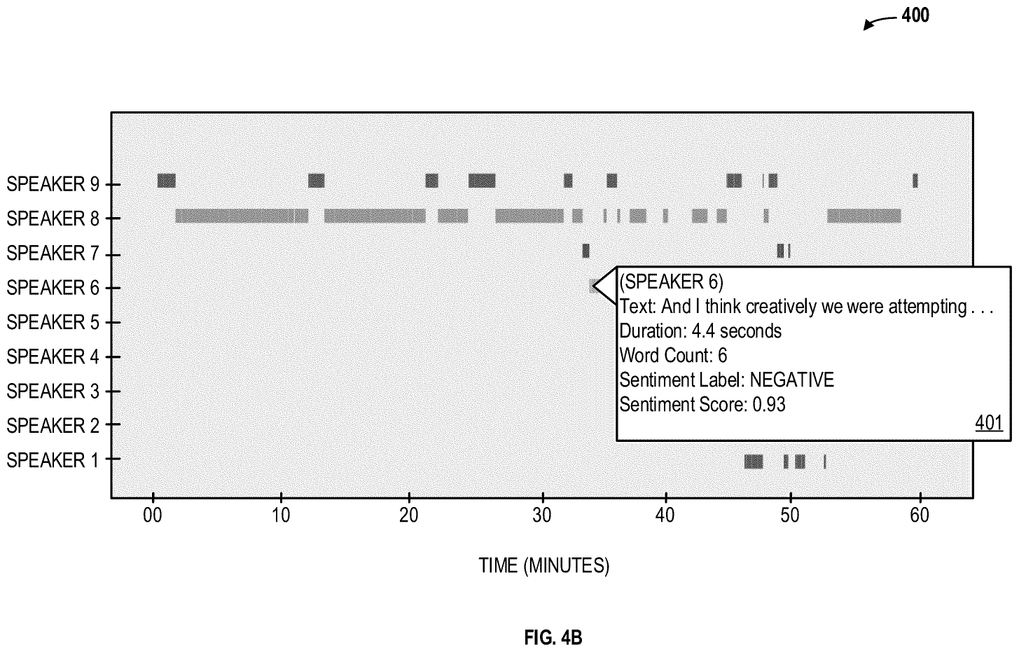

FIGS. 4A-4B show an example interface 400 for displaying data associated with the transcription information. For example, a graphical user interface 400 may be displayed to the user that includes a graphical depiction of the words spoken by each speaker. In an example, as shown in FIGS. 4A-4B, a plurality of speakers (e.g., nine speakers) may have participated in the focus group discussion and the audio data may include the audio of the plurality of speakers. The interface 400 may display a graph indicative of the amount of words spoken by each speaker at one or more times. As shown in FIGS. 4A-4B, speaker 8 may have talked the most during the focus group, followed by speaker 9. In addition, FIGS. 4A-4B show that the remain speakers did not begin speaking until the last 30 minutes of the focus group discussion. In an example, as shown in FIG. 4B, a user may interact with the graph on the interface 400 and cause the interface 400 to display further information (e.g., 401) regarding the words spoken by each speaker, such as text of the words spoken, a duration associated with the selected words, a word count, a sentiment label, and a sentiment score. For example, the interface 400 may display that the audience exhibited negative sentiment when the speaker said “And I think creatively we were attempting . . . ” In addition, a sentiment score (e.g., 0.93) may be calculated indicative of the negative sentiment.

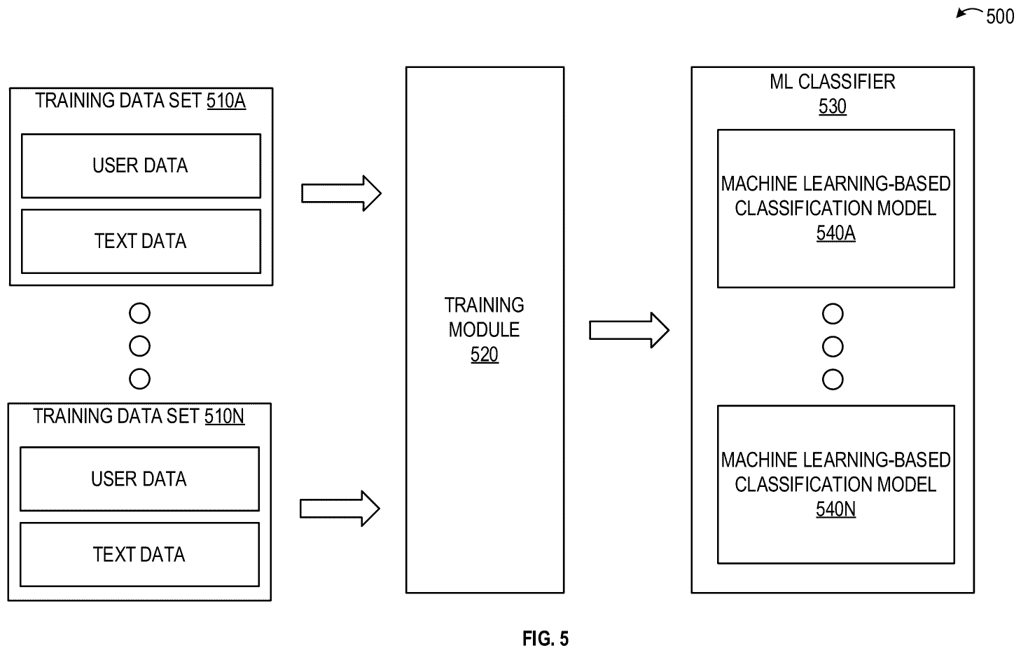

FIG. 5 shows an example system 500 that is configured to use machine learning techniques to train, based on an analysis of one or more training datasets 510A-510N by a training module 520, one or more machine learning-based classifiers 530. For example the machine learning modules/models 159 (e.g., the language processing AI module, the generative AI module, and/or the predictive AI module) may be trained according to system 500. The one or more machine learning models 530, once trained, may be configured to generate transcription information based on audio data, generate insight information based on the transcription information, and generate an audience sentiment report based on the insight information. For example, a first machine learning model (e.g., language processing AI module) of the one or more machine learning models 530, once trained, may generate the transcription information based on the audio data, a second machine learning model (e.g., generative AI module), once trained, may generate the insight information based on the transcription information, and a third machine learning model (e.g., predictive AI module), once trained, may generate the audience sentiment report based on the insight information. The audience sentiment report may be sent, to one or more third parties, for example, for use in developing audience insight information, for use in developing marketing/advertisement campaigns, and/or for product development. A dataset indicative of, or comprising, user data (e.g., voice data, user profile data, audience data, etc.) and text data and a labeled (e.g., predetermined/known) prediction indicating a correlation between user data and text data corresponding to one or more topics that are of interest to one or more audience members or not may be used by the machine learning module 520 to train the one or more machine learning models 530. Each item of the user data and/or the text data in the dataset may be associated with a plurality of features that are present within the user data and/or the text data. The plurality of features and the labeled predictions may be used to train the at least one machine learning model 530.

The training datasets 510A-510N may each comprise one or more portions of the user data and/or the text data. The user data and/or the text data may have a labeled (e.g., predetermined) prediction and one or more labeled features. Each item of the user data and/or the text data may be randomly assigned to each of the training datasets 510A-510N and/or to one or more testing datasets. In some implementations, the assignment of the items of the user data and/or the text data to a training dataset or a testing dataset may not be completely random. In this case, one or more criteria may be used during the assignment, such as ensuring that similar numbers of user data and/or text data with different predictions and/or features are in each of the training and testing datasets. In general, any suitable method may be used to assign the user data and/or the text data to the training or testing datasets, while ensuring that the distributions of predictions and/or features are somewhat similar in the training dataset and the testing dataset.

The machine learning module 520 may use portions of the training datasets 510A-510N to determine one or more features that are indicative of a high prediction. That is, the machine learning module 520 may determine which features present within the user data and/or the text data are correlative with a high prediction. The one or more features indicative of a high prediction may be used by the machine learning module 520 to train the machine learning model 530. For example, the machine learning module 520 may train the machine learning models 530 by extracting a feature set (e.g., one or more features) from a first portion of the training datasets 510A-510N according to one or more feature selection techniques. The machine learning module 520 may further define the feature set obtained from the training datasets 510A-510N by applying one or more feature selection techniques to a second portion in the training datasets 510A-510N that includes statistically significant features of positive examples (e.g., high predictions) and statistically significant features of negative examples (e.g., low predictions). The machine learning module 520 may train the machine learning models 530 by extracting a feature set from another training dataset of the training datasets 510A-510N that includes statistically significant features of positive examples (e.g., high predictions) and statistically significant features of negative examples (e.g., low predictions).

The machine learning module 520 may extract a feature set from the training datasets 510A-510N in a variety of ways. For example, the machine learning module 520 may extract a feature set from the training datasets 510A-510N using a classification module (e.g., a machine learning model). The machine learning module 520 may perform feature extraction multiple times, each time using a different feature-extraction technique. In one example, the feature sets generated using the different techniques may each be used to generate different machine learning models 540 (e.g., language processing AI model, generative AI model, and/or predictive AI model). For example, the feature set with the highest quality features (e.g., most indicative of interest or not of interest to a particular user(s)) may be selected for use in training. The machine learning module 520 may use the feature set(s) to build one or more machine learning models 540A-540N that are configured to generate transcription information based on audio data (e.g., via a language processing AI model), generate insight information based on the transcription information (e.g., via a generative AI model), and generate an audience sentiment report based on the insight information (e.g., via a predictive AI model).

The training datasets 510A-510N may be analyzed to determine any dependencies, associations, and/or correlations between features and the labeled predictions in the training datasets 510A-510N. The identified correlations may have the form of a list of features that are associated with different labeled predictions (e.g., topics with positive audience sentiment vs. topics with negative audience sentiment). The term “feature,” as used herein, may refer to any characteristic of an item of data that may be used to determine whether the item of data falls within one or more specific categories or within a range. By way of example, the features described herein may comprise one or more features present within the user data and/or the text data that may be correlative (or not correlative as the case may be) with a feature associated with a topic with positive/negative audience sentiment.

A feature selection technique may comprise one or more feature selection rules. The one or more feature selection rules may comprise a feature occurrence rule. The feature occurrence rule may comprise determining which features in the training datasets 510A-510N occur over a threshold number of times and identifying those features that satisfy the threshold as candidate features. For example, any features that appear greater than or equal to 5 times in the training datasets 510A-510N may be considered as candidate features. Any features appearing less than, for example, 5 times may be excluded from consideration as a candidate feature. Other threshold numbers may be used as well.

A single feature selection rule may be applied to select features or multiple feature selection rules may be applied to select features. The feature selection rules may be applied in a cascading fashion, with the feature selection rules being applied in a specific order and applied to the results of the previous rule. For example, the feature occurrence rule may be applied to a first training dataset of the training datasets 510A-510N to generate a first list of features. A final list of features may be analyzed according to additional feature selection techniques to determine one or more candidate feature groups (e.g., groups of features that may be used to determine a prediction). Any suitable computational technique may be used to identify the feature groups using any feature selection technique such as filter, wrapper, and/or embedded methods. One or more candidate feature groups may be selected according to a filter method. Filter methods include, for example, Pearson's correlation, linear discriminant analysis, analysis of variance (ANOVA), chi-square, combinations thereof, and the like. The selection of features according to filter methods are independent of any machine learning algorithms used by the system 500. Instead, features may be selected on the basis of scores in various statistical tests for their correlation with the outcome variable (e.g., a prediction).

As another example, one or more candidate feature groups may be selected according to a wrapper method. A wrapper method may be configured to use a subset of features and train the machine learning models 530 using the subset of features. Based on the inferences that may be drawn from a previous model, features may be added and/or deleted from the subset. Wrapper methods include, for example, forward feature selection, backward feature elimination, recursive feature elimination, combinations thereof, and the like. For example, forward feature selection may be used to identify one or more candidate feature groups. Forward feature selection is an iterative method that begins with no features. In each iteration, the feature which best improves the model is added until an addition of a new variable does not improve the performance of the model. As another example, backward elimination may be used to identify one or more candidate feature groups. Backward elimination is an iterative method that begins with all features in the model. In each iteration, the least significant feature is removed until no improvement is observed on removal of features. Recursive feature elimination may be used to identify one or more candidate feature groups. Recursive feature elimination is a greedy optimization algorithm which aims to find the best performing feature subset. Recursive feature elimination repeatedly creates models and keeps aside the best or the worst performing feature at each iteration. Recursive feature elimination constructs the next model with the features remaining until all the features are exhausted. Recursive feature elimination then ranks the features based on the order of their elimination.

As a further example, one or more candidate feature groups may be selected according to an embedded method. Embedded methods combine the qualities of filter and wrapper methods. Embedded methods include, for example, Least Absolute Shrinkage and Selection Operator (LASSO) and ridge regression which implement penalization functions to reduce overfitting. For example, LASSO regression performs L1 regularization which adds a penalty equivalent to absolute value of the magnitude of coefficients and ridge regression performs L2 regularization which adds a penalty equivalent to square of the magnitude of coefficients.

After the machine learning module 520 has generated a feature set(s), the machine learning module 520 may generate the one or more machine learning models 540A-540N (e.g., language processing AI module, generative AI module, and/or predictive AI module) based on the feature set(s). A machine learning model (e.g., any of the one or more machine learning models 540A-540N) may refer to a complex mathematical model for data classification that is generated using machine-learning techniques as described herein. In one example, a machine learning model may include a map of support vectors that represent boundary features. By way of example, boundary features may be selected from, and/or represent the highest-ranked features in, a feature set.

The machine learning module 520 may use the feature sets extracted from the training datasets 510A-510N to build the one or more machine learning models 540A-540N for each classification category (e.g., transcription data based on audio input, insight data of the transcription data, and/or “topics with positive audience sentiment” and “topics with negative audience sentiment”). In some examples, the one or more machine learning models 540A-540N may be combined into a single machine learning model 540 (e.g., an ensemble model). Similarly, the machine learning model 530 may represent a single classifier containing a single or a plurality of machine learning models 540 and/or multiple classifiers containing a single or a plurality of machine learning models 540 (e.g., an ensemble classifier).

The extracted features (e.g., one or more candidate features) may be combined in the one or more machine learning models 540A-540N that are trained using a machine learning approach such as discriminant analysis; decision tree; a nearest neighbor (NN) algorithm (e.g., k-NN models, replicator NN models, etc.); statistical algorithm (e.g., Bayesian networks, etc.); clustering algorithm (e.g., k-means, mean-shift, etc.); neural networks (e.g., reservoir networks, artificial neural networks, etc.); generative pre-trained transformer; support vector machines (SVMs); logistic regression algorithms; linear regression algorithms; Markov models or chains; principal component analysis (PCA) (e.g., for linear models); multi-layer perceptron (MLP) ANNs (e.g., for non-linear models); replicating reservoir networks (e.g., for non-linear models, typically for time series); random forest classification; a combination thereof and/or the like. The resulting machine learning model 530 may comprise a decision rule or a mapping for each candidate feature in order to assign a prediction to a class (e.g., of interest to a particular user vs. not of interest to the particular user). As described herein, the machine learning model 530 may be used to generate customized content. The candidate features and the machine learning model 530 may be used to determine predictions for user profiles and content items in the testing dataset.

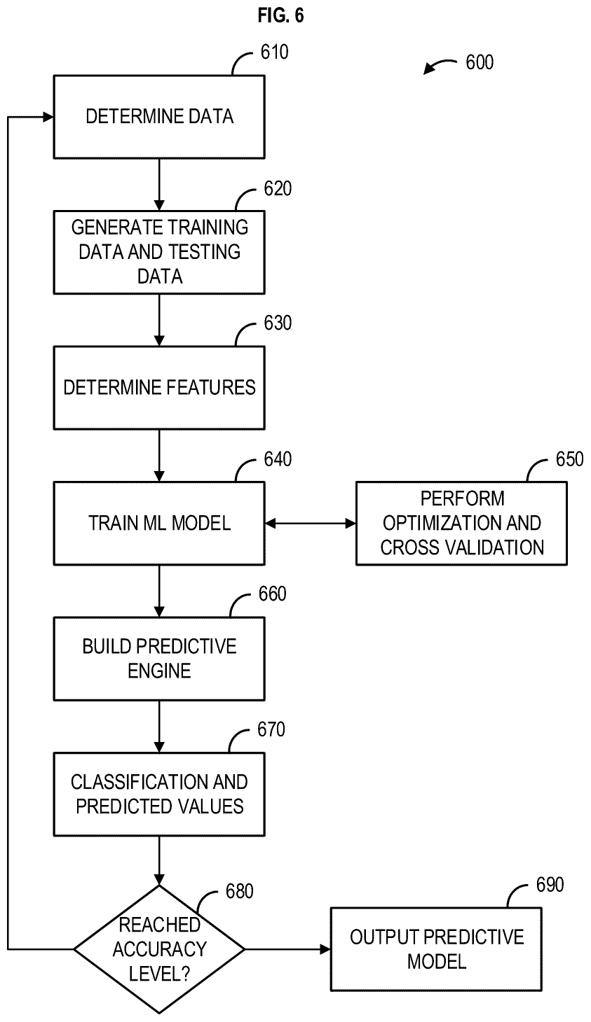

FIG. 6 shows a flowchart of an example training method 600 for generating the machine leaning-based classifiers 530 using the training module 520. For example, the machine learning modules/models (e.g., language processing AI module, generative AI module, and/or predictive AI module) may be trained according to method 600. The training module 520 may be implement using supervised, unsupervised, and/or semi-supervised (e.g., reinforcement based) machine learning-based classification models 540 (e.g., language processing AI module, generative AI module, and/or predictive AI module). The method 600 illustrated in FIG. 6 is an example of a supervised learning method; variations of this example of training method are discussed below, however, other training methods may be analogously implemented to train unsupervised and/or semi-supervised machine learning models.

At step 610, the training method 600 may determine (e.g., access, receive, retrieve, etc.) user data (e.g., voice data, user profile data, audience data, etc.) and/or text data. The user data and/or the text data may each comprise one or more features and a predetermined prediction. The training method 600 may generate, at step 620, a training dataset, and a testing dataset. The training dataset and the testing dataset may be generated by randomly assigning the user data and/or the text data to either the training dataset or the testing dataset. In some implementations, the assignment of the user data and/or the text data as training or test samples may not be completely random. As an example, only the user data and/or the text data for a specific feature(s) and/or range(s) of predetermined predictions may be used to generate the training dataset and the testing dataset. As another example, a majority of the user data and/or the text data for the specific feature(s) and/or range(s) of predetermined predictions may be used to generate the training dataset. For example, 75% of the user data and/or the text data for the specific feature(s) and/or range(s) of predetermined predictions may be used to generate the training dataset and 25% may be used to generate the testing dataset.

The training method 600 may determine (e.g., extract, select, etc.), at step 630, one or more features that may be used by, for example, a classifier to differentiate among different classifications (e.g., predictions). The one or more features may comprise a set of features. As an example, the training method 600 may determine a set features from the user data and/or the text data. As another example, a set of features may be determined from other user data and/or other text data associated with a specific feature(s) and/or range(s) of predetermined predictions that may be different than the specific feature(s) and/or range(s) of predetermined predictions associated with the user data and/or the text data of the training dataset and the testing dataset. In other words, the other user data and/or the other text data may be used for feature determination/selection, rather than for training. The training dataset may be used in conjunction with the other user data and/or the other text data to determine the one or more features. The other user data and/or the other text data may be used to determine an initial set of features, which may be further reduced using the training dataset.

The training method 600 may train one or more machine learning models (e.g., one or more machine learning models, neural networks, deep-learning models, text-based learning models, large language models, natural language processing applications/models, generative pre-trained transformers, etc.) using the one or more features at step 640. In one example, the machine learning models may be trained using supervised learning. In another example, other machine learning techniques may be used, including unsupervised learning and semi-supervised. The machine learning models trained at step 640 may be selected based on different criteria depending on the problem to be solved and/or data available in the training dataset. In an example, machine learning models may suffer from different degrees of bias. Accordingly, more than one machine learning model may be trained at 640, and then optimized, improved, and cross-validated at step 650.

The training method 600 may select one or more machine learning models to build the machine learning models 530 at step 660. The machine learning models 530 may be evaluated using the testing dataset. The machine learning models 530 may analyze the testing dataset and generate classification values and/or predicted values (e.g., predictions) at step 670. Classification and/or prediction values may be evaluated at step 680 to determine whether such values have achieved a desired accuracy level. Performance of the machine learning models 530 may be evaluated in a number of ways based on a number of true positives, false positives, true negatives, and/or false negatives classifications of the plurality of data points indicated by the machine learning models 530.

For example, the false positives of the machine learning models 530 may refer to a number of times the machine learning models 530 incorrectly assigned a high prediction to a data input associated with a low predetermined prediction. Conversely, the false negatives of the machine learning models 530 may refer to a number of times the machine learning model assigned a low prediction to a data input associated with a high predetermined prediction. True negatives and true positives may refer to a number of times the machine learning models 530 correctly assigned predictions to each data input based on the known, predetermined prediction for each data input. Related to these measurements are the concepts of recall and precision. Generally, recall refers to a ratio of true positives to a sum of true positives and false negatives, which quantifies a sensitivity of the machine learning models 530. Similarly, precision refers to a ratio of true positives a sum of true and false positives. When such a desired accuracy level is reached, the training phase ends and the machine learning model 530 may be output at step 690; when the desired accuracy level is not reached, however, then a subsequent iteration of the training method 600 may be performed starting at step 610 with variations such as, for example, considering a larger collection of user data and/or text data. The machine learning model 530 may be output at step 690.

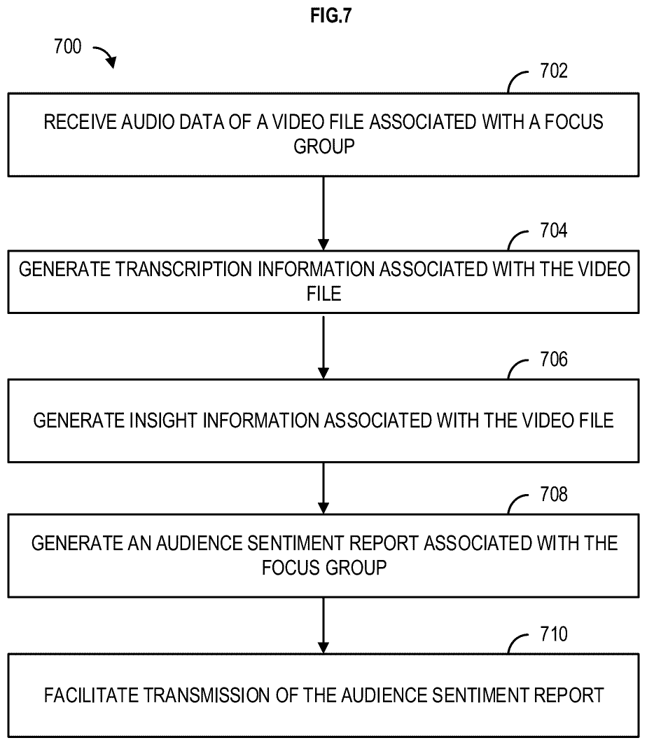

FIG. 7 shows a flowchart of an example method 700 for generating an audience sentiment report based on audio data of a video file associated with a focus group. Method 700 may be implemented by a computing device (e.g., backend platform device 101, servers 106, etc.). At step 702, audio data of a video file associated with a focus group may be received. For example, the audio data may be received by the computing device (e.g., backend platform device 101, servers 106, etc.). The audio data may be associated with, or comprise audio of, one or more speakers (e.g., one or more individuals that were talking during the focus group discussion). In an example, the audio data may be extracted from the video file. The video file may be generated (e.g., recorded) during the focus group discussion. The audio data may be received in a first format, wherein the audio data may be processed to be converted from the first format to a second format (e.g., MP3, WAV, AAC, WMA, MP4, M4A, FLAC, etc.).

At step 704, transcription information associated with the video file may be generated via a language processing artificial intelligence (AI) module based on the audio data. For example, the transcription information may be generated by the computing device (e.g., backend platform device 101, servers 106, etc.) via the language processing AI module. The language processing AI module may comprise one or more of a text-based learning model, a large language model, or a natural language processing application. The transcription information may comprise text data associated with the one or more speakers. For example, text data may be extracted, or generated, from the audio data via the language processing AI module. One or more speakers of, or associated with, the audio data may be determined via the language processing AI module. The one or more speakers may be associated with the text data via the language processing AI module. The text data associated with the one or more speakers may be synchronized with one or more segments of the audio data via the language processing AI module (e.g., a diarization process). For example, the audio data may comprise timing information. Each speaker of the one or more speakers may be associated with text data, and the text data associated with each speaker may be synchronized with the timing information of the audio data. In an example, the language processing AI module may comprise a plurality of language processing AI modules. For example, a first language processing AI module may extract, or generate, the text data, a second language processing AI module may determine the one or more speakers of the audio data, and a third language processing AI module may associate the one or more speakers with the text data of the audio data.

At step 706, insight information associated with the video file may be generated via a generative AI module based on the transcription information. For example, the insight information may be generated by the computing device (e.g., backend platform device 101, servers 106, etc.) via the generative AI module. The insight information may comprise one or more of a text summary associated with the video file, one or more questions associated with the video file, or one or more topics associated with the video file. For example, the generative AI module may generate a text summary of what each speaker discussed and/or the topics discussed by each speaker. In one example, the generative AI module may also generate one or more questions (e.g., survey questions) that may be presented to audience members of the focus group or future focus groups. In addition, reasoning for each question of the one or more questions may be generated. For example, the questions may be implemented in order to improve the direction of a next focus group survey, or set of questions. In an example, the generative AI module may generate one or more survey questions that may be distributed across one or more focus groups.

At step 708, an audience sentiment report associated with the focus group may be generated via a predictive AI module. For example, the audience sentiment report may be generated by the computing device (e.g., backend platform device 101, servers 106, etc.) via the predictive AI module. The audience sentiment report may comprise information indicative of audience sentiment associated with the one or more topics of the video file associated with the focus group. In an example, the audience sentiment report may comprise an aggregation of the transcription information (e.g., text data and speaker and text diarization information). In an example, the audience sentiment report may compile statistics of the focus group discussion such as when each speaker spoke or did not speak, the topics discussed by each speaker, how long each speaker spoke, how many words were spoken by each speaker, audience sentiment labels for each topic, and/or audience sentiment scores for each topic.

At step 710, the audience sentiment report may be transmitted. For example, the audience sentiment report may be transmitted by the computing device (e.g., backend platform device 101, servers 106, etc.). Before transmitting the audience sentiment report is transmitted, the audience sentiment report may be formatted into one or more data file formats. The one or more data file formats may comprise one or more of an XML file, a PDF file, or a Word document file.

In an example, one or more queries may be received. The generative AI module, or an additional/second generative AI module may generate one or more outputs based on the one or more queries. The one or more outputs may comprise one or more of sentiment data associated with each speaker of the one or more speakers, one or more topics associated with each speaker, sentiment data associated with each topic of one or more topics associated with the focus group, sentiment data and one or more topics associated with one or more questions, or one or more questions and reasoning associated with each question of the one or more questions. For example, the generative AI module, or an additional/second generative AI module may further narrow or filter data of the audience sentiment report based on the one or more queries. In one example, one or more summaries of the audience sentiment data may be generated based on the one or more queries. In another example, the one or more topics may be analyzed by based on the one or more queries. In another example, the results of the audience sentiment report may be grouped based on the one or more queries. In another example, the questions (e.g., future audience questions) and reasoning for the questions may be updated/generated based on the one or more queries and the audience report may be updated/generated based on the one or more queries.

In an example, additional video files may be received. The additional video files may be associated with an overall larger focus group, wherein the larger focus group may comprise smaller sub-groups. The sub-groups may be associated with one or more sub-topics, or sub-categories of the larger focus group. An overall audience sentiment report may be generated for the focus group that may include sub-reports for the sub-groups of the focus group. For example, a video file (e.g., additional video files) may be generated based on each sub-group discussion. Audio data of the additional video files may be extracted/generated. Transcription information associated with the additional video files may be generated via the language AI module based on the audio data. Insight information associated with the additional video files may be generated by the generative AI module based on the transcription information associated with the additional video files. One or more additional audience reports may be generated via the predictive AI module based on the insight information associated with the additional video files.

The methods and systems can employ artificial intelligence (AI) techniques such as machine learning and iterative learning. Examples of such techniques comprise, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, such as: matters of logic with respect to arrangement of steps or operational flow; plain meaning derived from grammatical organization or punctuation; the number or type of embodiments described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as examples only, with a true scope and spirit being indicated by the following claims.

What is claimed is:

1. A method for utilizing a plurality of artificial intelligence (AI) modules to determine audience sentiment, the method comprising:
receiving, by a computing device, audio data of a video file associated with a focus group;
generating, via a language processing AI module, based on the audio data, transcription information associated with the video file;
generating, via a generative AI module, based on the transcription information, insight information associated with the video file;
generating, via a predictive AI module, based on the insight information, an audience sentiment report associated with the focus group; and
facilitating, by the computing device, transmission of the audience sentiment report.

2. The method of claim 1, wherein the transcription information comprises text data associated with audio data associated with one or more speakers.

3. The method of claim 1, wherein the language processing AI module comprises one or more of a text-based learning model, a large language model, or a natural language processing application.

4. The method of claim 1, wherein receiving the audio data of the video file comprises:
extracting the audio data from the video file; and
converting the audio data from a first format to a second format.

5. The method of claim 1, wherein generating, via the language processing AI module, based on the audio data, the transcription information associated with the video file comprises:
extracting, via the language processing AI module, text data from the audio data;
determining, via the language processing AI module, one or more speakers associated with the audio data;
associating, via the language processing AI module, the one or more speakers with the text data; and
synchronizing, via the language processing AI module, the text data associated with the one or more speakers with one or more segments of the audio data.

6. The method of claim 1, wherein the insight information comprises one or more of a text summary associated with the video file, one or more questions associated with the video file, or one or more topics associated with the video file.

7. The method of claim 1, wherein the audience sentiment report comprises information indicative of audience sentiment associated with one or more topics associated with the focus group.

8. The method of claim 1, further comprising causing, based on the audience sentiment report, output of audience sentiment data.

9. The method of claim 1, further comprising generating, via a second generative AI module, based on one or more queries associated with the audience sentiment report, one or more outputs.

10. The method of claim 9, wherein the one or more outputs comprise one or more of sentiment data associated with each speaker of one or more speakers, one or more topics associated with each speaker, sentiment data associated with each topic of one or more topics associated with the focus group, sentiment data and one or more topics associated with one or more questions, or one or more questions and reasoning associated with each question of the one or more questions.

11. An apparatus comprising:
one or more processors; and
a memory storing processor-executable instructions that, when executed by the one or more processors, cause the apparatus to:
receive audio data of a video file associated with a focus group;
generate, via a language processing AI module, based on the audio data, transcription information associated with the video file;
generate, via a generative AI module, based on the transcription information, insight information associated with the video file;
generate, via a predictive AI module, based on the insight information, an audience sentiment report associated with the focus group; and
facilitate transmission of the audience sentiment report.

12. The apparatus of claim 11, wherein the transcription information comprises text data associated with audio data associated with one or more speakers.

13. The apparatus of claim 11, wherein the language processing AI module comprises one or more of a text-based learning model, a large language model or a natural language processing application.

14. The apparatus of claim 11, wherein the processor-executable instructions that, when executed by the one or more processors, cause the apparatus to receive the audio data of the video file, further cause the apparatus to:
extract the audio data from the video file; and
convert the audio data from a first format to a second format.

15. The apparatus of claim 11, wherein the processor-executable instructions that, when executed by the one or more processors, cause the apparatus to generate, via the language processing AI module, based on the audio data, the transcription information associated with the video file, further cause the apparatus to:
extract, via the language processing AI module, text data from the audio data;
determine, via the language processing AI module, one or more speakers associated with the audio data;
associate, via the language processing AI module, the one or more speakers with the text data; and
synchronize the text data associated with the one or more speakers with one or more segments of the audio data.

16. The apparatus of claim 11, wherein the insight information comprises one or more of a text summary associated with the video file, one or more questions associated with the video file, or one or more topics associated with the video file.

17. The apparatus of claim 11, wherein the audience sentiment report comprises information indicative of audience sentiment associated with one or more topics associated with the focus group.

18. The apparatus of claim 11, wherein the processor-executable instructions, when executed by the one or more processors, further cause the apparatus to output audience sentiment data based on the audience sentiment report.

19. The apparatus of claim 11, wherein the processor-executable instructions, when executed by the one or more processors, further cause the apparatus to generate, via a second generative AI module, based on one or more queries associated with the audience sentiment report, one or more outputs.

20. The apparatus of claim 19, wherein the one or more outputs comprise one or more of sentiment data associated with each speaker of one or more speakers, one or more topics associated with each speaker, sentiment data associated with each topic of one or more topics associated with the focus group, sentiment data and one or more topics associated with one or more questions, or one or more questions and reasoning associated with each question of the one or more questions.
